(19) United States
(12) Patent Application Publication
(10) Pub. No.: US 2009/0227263 A1
(43) Pub. Date: Sep. 10, 2009

(54) METHOD AND APPARATUS FOR USING LOAD INDICATION FOR INTEREFERENCE MITIGATION IN A WIRELESS COMMUNICATION SYSTEM

(75) Inventors: Avneesh Agrawal, San Diego, CA (US); Tingfang Ji, San Diego, CA (US); Aamod Khandekar, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/206,603

(22) Filed: Sep. 8, 2008

Related U.S. Application Data
(60) Provisional application No. 60/971,219, filed on Sep. 10, 2007.
(60) Provisional application No. 61/014,668, filed on Dec. 18, 2007.

(51) Int. Cl. H04W 72/04; H04B 15/00

(52) U.S. Cl. 455/452.1; 455/453; 455/63.1

(57) ABSTRACT

Techniques for mitigating interference in a wireless communication system are described. In an aspect, a base station may periodically broadcast a load indication to convey information such as whether or not to use interference mitigation, which interference mitigation scheme to use, resources to apply interference mitigation, duration of interference mitigation, etc. Terminals may receive the load indication and perform interference mitigation as indicated by the load indication. In one design, a terminal may receive a load indication from a base station that the terminal desires to access. The terminal may determine whether to obtain reserved resources having reduced interference based on the load indication. In another design, a terminal may receive a load indication from a neighbor base station. The terminal may determine whether to reduce its transmit power or to request for resources prior to transmission based on the load indication.

The present application claims priority to provisional U.S. Application Ser. No. 60/971,219, entitled “SUPERFRAME PREAMBLE WITH LOAD INDICATION,” filed Sep. 10, 2007, and U.S. Application Ser. No. 61/014,668, entitled “SUPERFRAME PREAMBLE WITH LOAD INDICATION,” filed Dec. 18, 2007, both assigned to the assignee hereof and incorporated herein by reference.

### BACKGROUND

I. Field

The present disclosure relates generally to communication, and more specifically to techniques for mitigating interference in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of base stations that can support communication for a number of terminals. A terminal may communicate with a base station via the downlink and uplink. The downlink (or forward link) refers to the communication link from the base station to the terminal, and the uplink (or reverse link) refers to the communication link from the terminal to the base station.

Each base station may transmit data to zero or more terminals on the downlink and may receive data from zero or more terminals on the uplink at any given moment. On the downlink, a transmission from a base station to a terminal may observe interference due to transmissions from neighbor base stations. On the uplink, a transmission from a terminal to a base station may observe interference due to transmissions from other terminals communicating with neighbor base stations. For both the downlink and uplink, the interference due to interfering base stations and interfering terminals may degrade performance.

Various interference mitigation schemes or protocols may be used to mitigate strong interference from other transmissions in the same geographical or radio frequency vicinity. These interference mitigation schemes may attempt to orthogonalize transmissions from interfering stations in time, frequency, and/or code. Each transmission may then observe less or no interference from other transmissions and may thus achieve better performance. However, these interference mitigation schemes may have high overhead for signaling messages exchanged between base stations and terminals in order to implement interference mitigation.

There is therefore a need in the art for techniques to mitigate interference with less overhead.

### SUMMARY

Techniques for mitigating interference in a wireless communication system with less overhead are described herein. In an aspect, a base station may periodically broadcast a load indication to convey information such as whether or not to use interference mitigation, which interference mitigation scheme to use among multiple possible interference mitigation schemes, time and/or frequency resources to apply interference mitigation, duration of interference mitigation, performance metrics for the base station, and/or other information pertinent for interference mitigation. Terminals within communication range of the base station may receive the load indication and may perform interference mitigation as indicated by the load indication.

In one design, a terminal may receive a load indication from a base station that the terminal desires to access. The terminal may determine from the load indication whether to obtain reserved resources having reduced interference from interfering stations. In another design, a terminal may receive a load indication from a neighbor base station. The terminal may determine whether to reduce its transmit power, to request for resources prior to transmission, or to perform some other action based on the load indication.

Various aspects and features of the disclosure are described in further detail below.

### BRIEF DESCRIPTION OF THE DRAWINGS

FIG. 1 shows a wireless communication system.

FIG. 2 shows a transmission scheme for a load indication.

FIG. 3 shows a design for obtaining reserved resources for downlink broadcast and uplink access.

FIG. 4 shows a design for obtaining reserved resources for uplink data.

FIG. 5 shows a process performed by a terminal for interference mitigation.

FIG. 6 shows an apparatus for interference mitigation at the terminal.

FIG. 7 shows a process performed by a base station for interference mitigation.

FIG. 8 shows an apparatus for interference mitigation at the base station.

FIG. 9 shows a block diagram of the terminal and the base station.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2).

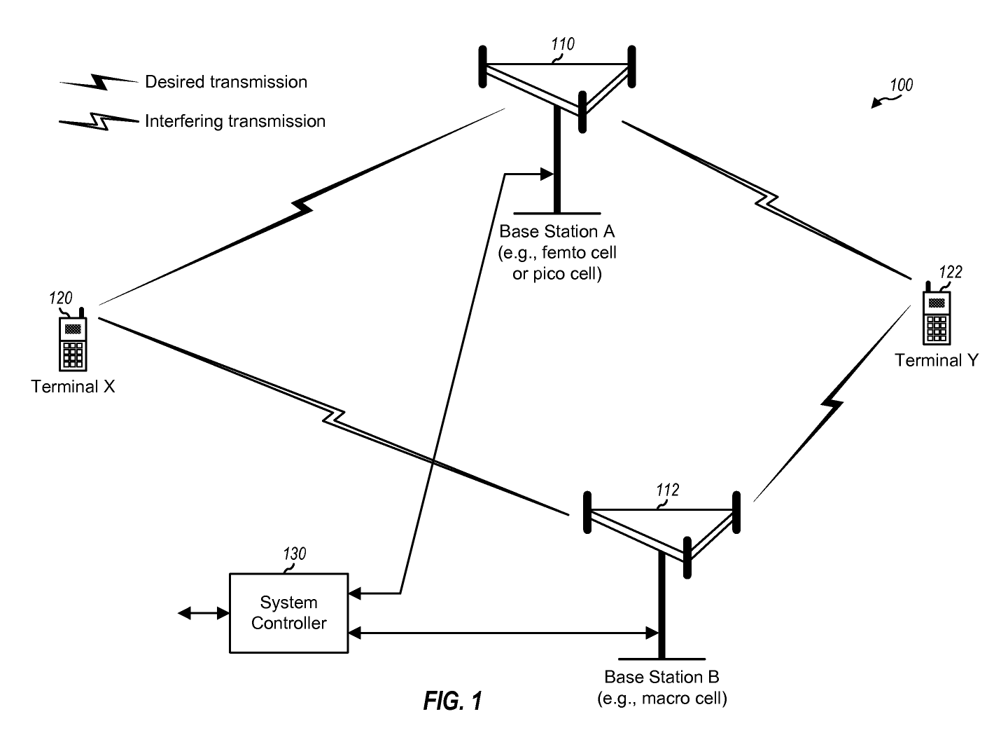

FIG. 1 shows a wireless communication system 100, which may include a number of base stations and other network entities. For simplicity, FIG. 1 shows only two base stations 110 and 112, which are also referred to as base stations A and B, respectively, and one system controller 130. A base station may be a fixed station that communicates with the terminals and may also be referred to as an access point, a Node B, an evolved Node B (eNB), etc. A base station may provide communication coverage for a particular geographic area. The overall coverage area of a base station may be partitioned into smaller areas, and each smaller area may be served by a respective base station subsystem. The term “cell” can refer to a coverage area of a base station and/or a base station subsystem serving this coverage area, depending on the context in which the term is used.

A base station may provide communication coverage for a macro cell, a pico cell, a femto cell, and/or other types of cell. A macro cell may cover a relatively large geographic area (e.g., several kilometers in radius) and may support communication for all terminals with service subscription in the system. A pico cell may cover a relatively small geographic area and may support communication for all terminals with service subscription. A femto cell may cover a relatively small geographic area (e.g., a home) and may support communication for a set of terminals having association with the femto cell (e.g., terminals belonging to residents of the home). The terminals supported by a femto cell may belong in a closed subscriber group (CSG). A base station for a macro cell may be referred to as a macro base station, a base station for a pico cell may be referred to as a pico base station, and a base station for a femto cell may be referred to as a home base station. The techniques described herein may be used for all types of base station and all types of cell.

System controller 130 may couple to a set of base stations and provide coordination and control for these base stations. System controller 130 may be a single network entity or a collection of network entities. System controller 130 may communicate with base stations 110 and 112 via a backhaul, as shown in FIG. 1. Base stations 110 and 112 may also communicate with one another, e.g., via a direct wireless or wireline interface or via a data network such as the Internet.

System 100 may support communication for a number of terminals. For simplicity, FIG. 1 shows only two terminals 120 and 122, which are also referred to as terminals X and Y, respectively. A terminal may be stationary or mobile and may also be referred to as an access terminal (AT), a mobile station (MS), a user equipment (UE), a subscriber unit, a station, etc. A terminal may be a cellular phone, a personal digital assistant (PDA), a wireless modem, a wireless communication device, a handheld device, a laptop computer, a cordless phone, etc. The terms “terminal” and “user” are used interchangeably herein. A terminal may communicate with a serving base station and may cause interference to and/or observe interference from other stations. A serving base station is a base station designated to serve a terminal on the downlink and/or uplink. An interfering base station is a base station causing interference to a terminal on the downlink. An interfering terminal is a terminal causing interference to another terminal on the uplink. An interfering station may be an interfering base station or an interfering terminal.

Terminal 120 may desire to communicate with base station 110 but may observe strong interference from base station 112 on the downlink and/or from terminal 122 on the uplink. For example, base station 110 may be a home base station covering a femto cell with restricted association and may transmit at a much lower power level than base station 112, which may be a macro base station. Terminal 120 may then receive much higher power from interfering base station 112 compared to home base station 110 on the downlink. Terminal 122 may communicate with base station 112 and may transmit at much higher power level than terminal 120. Base station 110 may then receive much higher power from interfering terminal 122 compared to terminal 120 on the uplink.

An interference mitigation scheme may be used to orthogonalize the downlink transmissions from base stations 110 and 112 so that terminal 120 can observe less interference from interfering base station 112. An interference mitigation scheme may also be used to orthogonalize the uplink transmissions from terminals 120 and 122 so that base station 110 can observe less interference from interfering terminal 122. Various signaling messages may be sent on the downlink and uplink to support interference mitigation on each link. These signaling messages represent overhead for implementing interference mitigation. The overhead may be particularly severe in deployments where many base stations are close to one another. For example, a femto cell deployment may have tens of home base stations in a single apartment building. The overhead may be prohibitive when many of the base stations do not have active sessions.

In an aspect, a load indication may be used to support interference mitigation with less overhead. The load indication may also be referred to as load information, loading information, etc. The load indication may convey information used for interference mitigation, information used for system access and communication with a base station, etc. The load indication may be broadcast periodically to all terminals within communication range of the base station. Communication range is the range in which a signal from a base station can be received by a terminal, or vice versa.

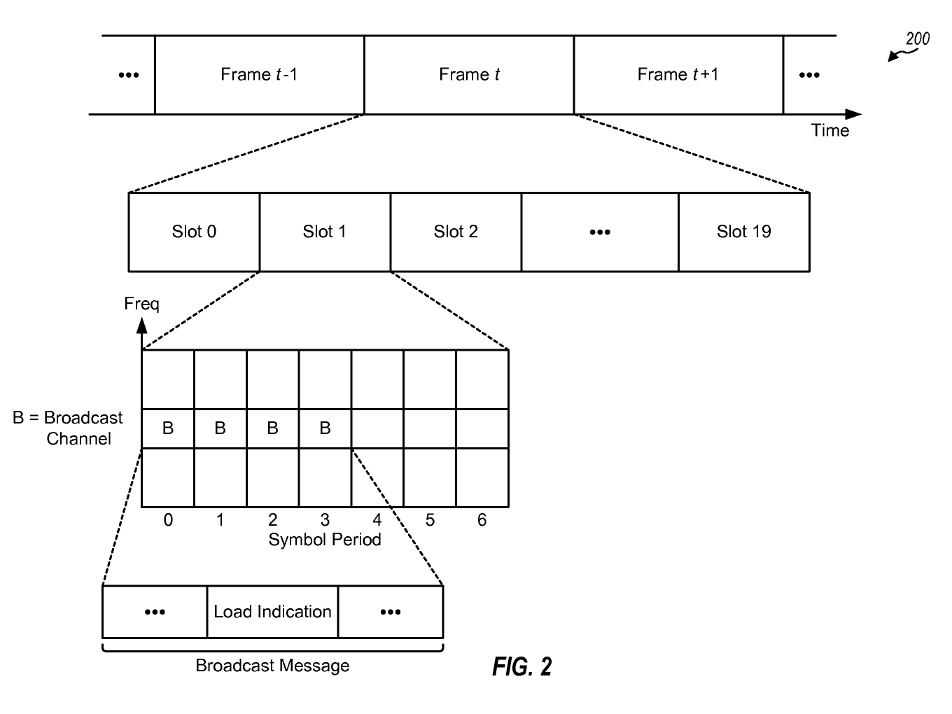

FIG. 2 shows a design of a transmission scheme 200 for the load indication. The transmission timeline for the downlink may be partitioned into units of radio frames. Each radio frame may cover a predetermined time duration, e.g., 10 milliseconds (ms), and may be partitioned into 20 slots with indices of 0 through 19. Each slot may cover a fixed or configurable number of symbol periods, e.g., six or seven symbol periods.

In the design shown in FIG. 2, the load indication may be sent in a broadcast message, which may include other information. The broadcast message may be processed and sent on a broadcast channel, which may be mapped to designated time and frequency resources. In the example shown in FIG. 2, the broadcast message may be sent on a set of subcarriers (e.g., 72 subcarriers) in four symbol periods of slot 1 in each radio frame.

In general, the load indication may be sent on a broadcast channel, a control channel, a traffic/data channel, a pilot channel, a preamble of a superframe covering a predetermined time duration, etc. The load indication may be sent in a transmission (e.g., a broadcast channel or a preamble) used by the terminals for system acquisition. The load indication may be sent periodically (i) whenever the channel or preamble carrying the load indication is transmitted or (ii) at a different rate.

The load indication may carry various types of information that may be used by terminals for interference mitigation and system operation. In one design, the load indication may convey one or more of the following:
Whether or not to use interference mitigation,
Which interference mitigation scheme to use from among multiple interference mitigation schemes,
Time and/or frequency resources to apply interference mitigation,
Duration of interference mitigation,
Performance metrics for a base station,
Backhaul capability, and
Other information related to interference mitigation or cell performance.

The load indication may indicate whether or not to use interference mitigation for downlink and/or uplink transmissions within communication range of a base station transmitting the load indication. The load indication may be set to a first value to indicate no need for interference mitigation, to a second value to indicate use of interference mitigation, etc. For example, if a base station is not serving any active users, then the load indication may indicate that neighbor base stations and terminals can operate as if this base station is not present. If the base station is serving active users, then the load indication may indicate that interference mitigation is to be used for terminals communicating with the base station and/or for terminals communicating with neighbor base stations.

The load indication may indicate a particular interference mitigation scheme to use for downlink and/or uplink transmissions within communication range of a base station transmitting the load indication. Different interference mitigation schemes may be used to achieve different levels of interference mitigation. For the downlink, a terminal may first receive broadcast information, then receive control information, then receive data. For the uplink, the terminal may first transmit an access request, then transmit control information, and then transmit data. Interference mitigation for downlink broadcast, downlink control, downlink data, uplink access, uplink control, and uplink data may be considered as different levels of interference mitigation and may be achieved with different interference mitigation schemes, as described below. The load indication may indicate whether to use interference mitigation for downlink broadcast, downlink control, downlink data, uplink access, uplink control, and/or uplink data.

A terminal may receive a load indication from a base station and may perform interference mitigation as indicated by the load indication. The terminal may perform interference mitigation in different manners (e.g., use different interference mitigation schemes) depending on whether the base station is serving the terminal or is a neighbor base station. For example, a load indication from a serving base station may indicate whether the terminal should obtain reserved resources having reduced interference for communication with the serving base station. A load indication from a neighbor base station may indicate whether the terminal should reduce transmit power on resources used by the neighbor base station for communication with its terminals.

The load indication may indicate frequency and time resources on which interference mitigation should be used. The available frequency and time resources may be partitioned into resource blocks or tiles. Each resource block may cover a predetermined frequency and time dimension, e.g., 12 subcarriers in one slot. The available resource blocks may be assigned indices. The load indication may provide indices of resource blocks on which interference mitigation should be used.

In one design, the load indication may indicate the frequency and time resources on which to use interference mitigation as well as the type of information (e.g., control, data, etc.) to send on the resources and/or the particular link (e.g., downlink or uplink) for which the resources are used. In another design, the load indication may indicate the frequency and time resources on which to use interference mitigation, and the type of information to send on the resources may be implicit or known a priori by the terminals. In yet another design, the load indication may indicate whether or not to use interference mitigation on predefined frequency and time resources. For example, the load indication may be a 1-bit value to indicate whether or not certain predefined resources should be shared via a predetermined interference mitigation scheme.

The load indication may indicate the time duration over which to apply interference mitigation. In one design, the load indication may comprise a 1-bit value to indicate whether or not to apply interference mitigation for a predetermined time duration, e.g., a predetermined number of radio frames, one superframe duration, etc. In another design, the load indication may comprise a multi-bit value to indicate a specific time duration for interference mitigation. The load indication may comprise (i) only the interference mitigation duration or (ii) any of the information described above along with the interference mitigation duration.

The load indication may convey performance metrics for a base station (or a cell). The performance metrics may comprise statistics such as mean and variance of throughputs and/or delays for terminals communicating with the base station, the throughput achieved by a predetermined percentage of terminals, the percentage of terminals achieving a predetermined throughput, etc. The performance metrics may also convey other information such as the number of terminals being served by the base station, the resources (e.g., in terms of time, bandwidth, power, etc.) available to newly arriving terminals, typically performance of terminals currently being served, etc. The performance metrics may be used by terminals to determine whether or not to access the base station. For example, if the performance metrics indicate heavy loading or a low average throughput for terminals communicating with the base station, then a terminal may choose to access another base station with lighter loading. The performance metrics may also be used by the terminals for interference mitigation. For example, a terminal may invoke interference mitigation if the average throughput for its serving base station is below a low threshold and may skip interference mitigation otherwise. As another example, a terminal may receive a message from a neighbor base station requesting reduction in interference from interfering terminals. The terminal may determine whether or not to respond to the message or the amount of reduction in transmit power based on the performance metrics for the neighbor base station. The terminal may also use the performance metrics to set one or more thresholds for interference mitigation, to determine how to respond to interference management messages, etc.

The load indication may also convey other information useful for interference mitigation and system operation. For example, the load indication may convey a transmission protocol used at a base station (e.g., whether the base station is a relay station), the type of interference mitigation to apply (e.g., transmit power reduction, interference nulling for multi-antenna base stations or terminals, etc.), capability of joint transmission/reception with a set of neighbor cells, etc.

A terminal may receive a load indication from a base station that the terminal desires to access. The terminal may determine whether or not to access the base station based on the load indication. For example, if the load indication conveys the average throughput, then the terminal may decide to access the base station if the average throughput is above a throughput threshold. This throughput threshold may be dependent on the data requirements of the terminal and/or other factors. The terminal may also determine whether or not to access the base station based on the interference mitigation scheme and/or other information conveyed in the load indication.

A terminal may receive a load indication from a serving base station and may operate in accordance with this load indication. For example, the terminal may utilize the interference mitigation scheme and/or the frequency and time resources conveyed in the load indication for communication with the serving base station.

A terminal may receive a load indication from a neighbor base station and may operate in accordance with this load indication. The terminal may determine which interference mitigation scheme, if any, to invoke for uplink and/or downlink transmission based on the load indication from the neighbor base station. The load indication may inform the terminal to skip interference mitigation, e.g., due to light or no loading at the neighbor base station. The terminal may then transmit at any power level, including high power levels that may de-sense the neighbor base station, over all frequency and time resources except for those allocated for uplink access. The load indication may inform the terminal to apply interference mitigation, e.g., due to heavy loading at the neighbor base station. For example, the terminal may request for uplink resources and may send transmission on granted resources. As another example, the terminal may transmit at a specified power level or lower without requesting for resources and may need to request for resources to transmit at higher power levels. The load indication may also inform the terminal to use an interference mitigation scheme with a shorter request and transmission delay, e.g., when the neighbor base station has light or no loading. The load indication may also inform the terminal to use an interference mitigation scheme with a longer request and transmission delay, e.g., when the neighbor base station has heavy loading. For both cases, the terminal may request for time frequency resources prior to transmission and may send transmission on granted resources.

A terminal may receive a load indication from one base station and may send all or part of the information from the load indication to another base station. The terminal may forward load indication information from a neighbor base station to a serving base station, or vice versa. A base station may also receive load indication information from another base station via over-the-air transmission or the backhaul.

A base station may use load indication information from other base stations in various manners. The base station may configure its control and traffic channel structure based on the load indication information from other base stations. For example, the base station may decide that interference mitigation is not needed for its control and traffic channels if the load indications from the neighbor base stations indicate light or no loading. Conversely, the base station may use interference mitigation for its control and traffic channels if the load indications from the neighbor base stations indicate heavy loading. The base station may also use performance metrics from the neighbor base stations for frequency planning and selecting interference mitigation schemes.

A base station may periodically transmit broadcast information on designated downlink resources for use by terminals to access the base station. Some uplink resources may be reserved for terminals to send access requests to the base station. Some downlink and uplink resources may also be reserved for downlink and uplink control channels to send control information/signaling messages for various procedures for system access, resource assignment, interference mitigation, etc. After successfully accessing the base station, a terminal may be assigned dedicated downlink and uplink resources for sending data on the downlink and uplink.

A base station may have few or no active terminals communicating with the base station. Furthermore, terminals may infrequently access the base station. This may be the case, for example, if the base station is a home base station that serves a femto cell and has restricted association. The base station may also be located near other home base stations and/or may be within the vicinity of macro base stations. In this case, the downlink and uplink transmissions for the base station may observe high interference unless these transmissions are sent on resources not used by other base stations and are orthogonalized with other transmissions for these other base stations. The base station may have some reserved downlink resources to periodically transmit broadcast information, some reserved uplink resources to receive access requests, some reserved downlink and uplink resources for control information, and/or some reserved downlink and uplink resources for data. The reserved downlink and uplink resources may be allocated exclusively to the base station, and neighbor base stations may avoid using these reserved resources. However, if the base station has few or no active terminals, then reserving downlink and uplink resources specifically for the base station may represent inefficient use of the available resources. The inefficiency may be more severe when there are other nearby base stations, each with few or no active terminals but having reserved resources that are used infrequently by that base station but not usable by other base stations.

In one design, a load indication from a base station may indicate whether a terminal should perform bootstrapping for communication with the base station. Bootstrapping is a process in which one or more base stations and one or more terminals coordinate to reserve resources for a recipient station, which may be a base station for downlink or a terminal for uplink. The reserved resources may have less or no interference from other stations and may be used by the recipient station to achieve good performance. Bootstrapping may be performed for downlink broadcast, downlink control, downlink data, uplink access, uplink control, and/or uplink data

A terminal may go through a series of steps in order to communicate with a base station. These steps may include receiving the broadcast information from the base station, sending an access request to the base station, exchanging control information with the base station for system access and resource assignment, and exchanging data with the base station on assigned resources. Bootstrapping may be performed for any of these steps to reserve downlink and/or uplink resources.

Bootstrapping of downlink broadcast may be performed if no downlink resources are reserved for sending broadcast information. A base station may forego sending broadcast information in order to avoid consuming downlink resources and causing interference to neighbor base stations. Whenever a terminal desires to receive broadcast information, a mechanism may be used as a bootstrap to reserve downlink resources for the base station to periodically send broadcast information.

Bootstrapping of uplink access may be performed if no uplink resources are reserved for sending access requests to a base station. The base station may periodically transmit broadcast information on reserved downlink resources. A terminal may receive the broadcast information and may desire to access the base station. A mechanism may be used as a bootstrap to reserve uplink resources for the terminal to send an access request to the base station.

Bootstrapping of downlink and uplink control may be performed if no resources are reserved for sending control information on the downlink and uplink, respectively. A base station may periodically transmit broadcast information on reserved downlink resources, and a terminal may send an access request on reserved uplink resources. A mechanism may be used as a bootstrap to reserve downlink and uplink resources for sending control information on the downlink and uplink. Bootstrapping for downlink and uplink control may be performed together or separately.

Bootstrapping of downlink and uplink data may be performed if no resources are reserved for sending data on the downlink and uplink, respectively. A base station may periodically transmit broadcast information on reserved downlink resources, a terminal may send an access request on reserved uplink resources, and the base station and the terminal may exchange control information on reserved downlink and uplink resources. A mechanism may be used as a bootstrap to reserve downlink and uplink resources for sending data on the downlink and uplink. Bootstrapping for downlink and uplink data may be performed together or separately.

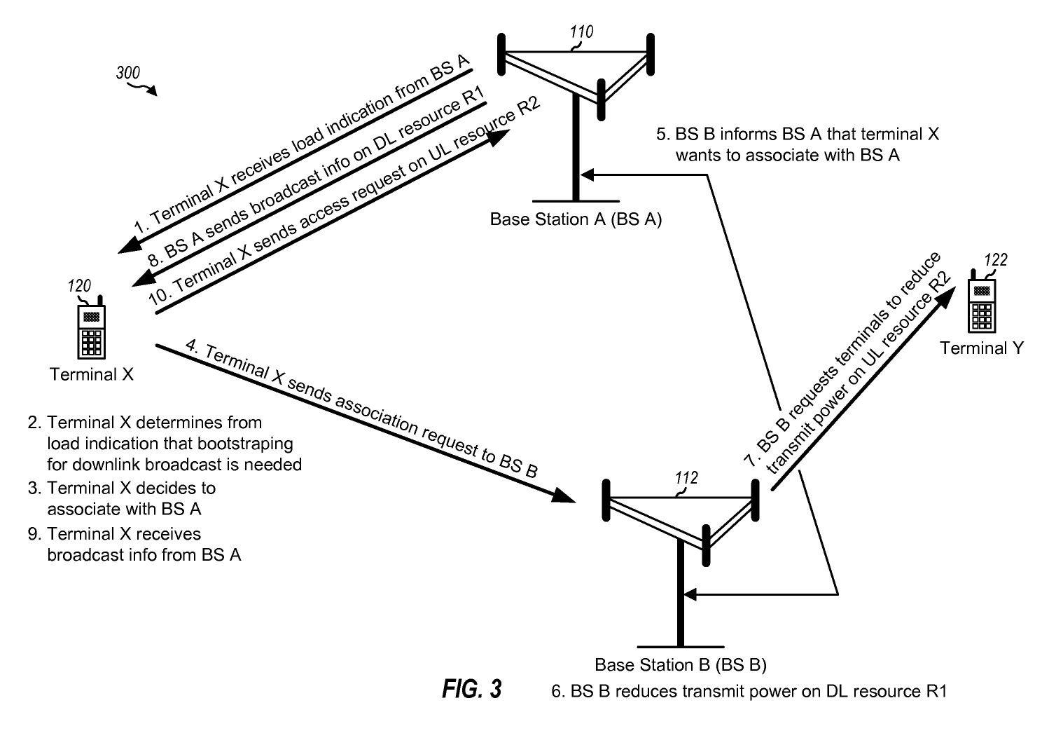

FIG. 3 shows a design of bootstrapping for downlink broadcast and uplink access. Terminal 120 may receive a load indication from base station 110 (step 1). Terminal 120 may determine from the load indication that broadcast information is not being transmitted by base station 110 and that bootstrap is needed for downlink broadcast (step 2). Terminal 120 may decide to associate with base station 110 (step 3). Since base station 110 may not have any reserved resources for uplink control, terminal 120 may send an association request to neighbor base station 112 to request association with base station 110 (step 4). Neighbor base station 112 may have reserved uplink resources for uplink control, which may be determined by terminal 120 from the broadcast information sent by base station 112.

Base station 112 may receive the association request from terminal 120. Base station 112 may send a message via the backhaul to inform base station 110 that terminal 120 desires to associate with base station 110 (step 5). Base station 112 may reduce its transmit power (e.g., to zero or a low level) on downlink (DL) resource R1, which may be reserved for downlink broadcast for base station 110 (step 6). Base station 112 may also instruct terminals (e.g., terminal 122) to reduce transmit power (e.g., to zero or a low level) on uplink (UL) resource R2, which may be reserved for uplink access for base station 110 (step 7). Resources R1 and R2 may be known a priori by both base stations 110 and 112 or may be signaled by base station 112 to base station 110 in step 5.

Base station 110 may receive the message from base station 112 and may send broadcast information on downlink resource R1 (step 8). Terminal 120 may receive the broadcast information and obtain applicable system parameters (step 9). Terminal 120 may then send an access request on uplink resource R2 to base station 110 (step 10). Resources R1 and R2 may be known a priori by terminal 120 or may be signaled to terminal 120 in the broadcast information.

FIG. 3 shows a specific design of bootstrapping for downlink broadcast and uplink access. The bootstrapping may also be performed in other manners. For example, the association request in step 4 may simply request interference mitigation on the downlink and/or uplink. The downlink and uplink interference mitigation triggers may or may not occur at the same time. The message in step 5 may or may not include specific information for terminal 120. The design in FIG. 3 shows use of power reduction to mitigate interference. Interference mitigation may also be achieved via other means, e.g., spatial coordination between base stations 110 and 112 and/or terminals 120 and 122.

In the design shown in FIG. 3, base station 110 and terminal 120 communicate via neighbor base station 112 to start transmission of broadcast information and to reserve resources for downlink broadcast and uplink access. Bootstrapping for downlink broadcast and uplink access may also be performed in other manners. In another design, terminal 120 may send the association request directly to base station 110 on predefined uplink resource or on different uplink resources. An access scheme such as Carrier Sense Multiple Access With Collision Avoidance (CSMA/CA) may be used to send the association request on uplink resources that may be used by other terminals.

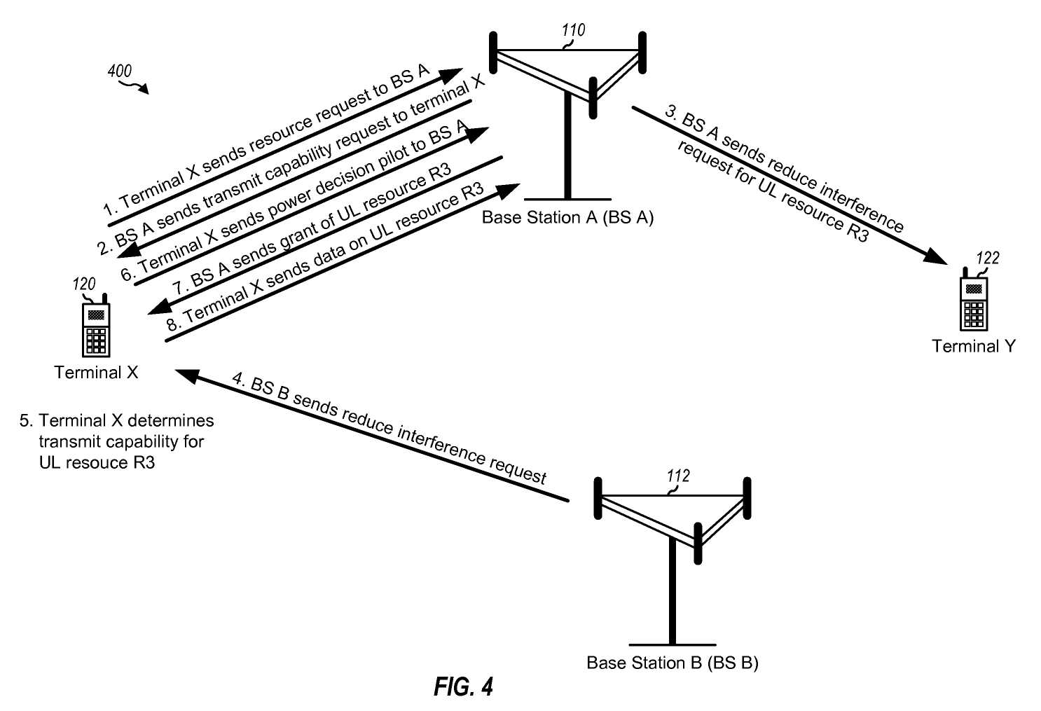

FIG. 4 shows a design of bootstrapping for uplink data. Terminal 120 may have data to send on the uplink and may send a resource request to base station 110 (step 1). Base station 110 may receive the resource request and, in response, may send a transmit capability request to terminal 120 (step 2). Base station 110 may also send a reduce interference request to interfering terminals in neighbor cells to request these terminals to reduce their transmit power (e.g., to zero or a low level) on uplink resource R3 (step 3). Each interfering terminal may reduce its transmit power on uplink resource R3 in response to the reduce interference request from base station 110.

Terminal 120 may receive the transmit capability request from base station 110 (step 2) and may also receive a reduce interference request from neighbor base station 112 (step 4). Terminal 120 may determine the maximum transmit power level that it can use on uplink resource R3 in order to comply with the reduce interference request (if any) from neighbor base station 112 (step 5). Terminal 120 may then send a power decision pilot to base station 110 to convey its transmit capability (step 6). The power decision pilot may be a pilot sent at the maximum transmit power level that terminal 120 can use on uplink resource R3. Base station 110 may schedule terminal 120 for uplink data transmission and may assign all or part of uplink resource R3 to terminal 120, e.g., based on the transmit capability of terminal 120 ascertained from the power decision pilot. Base station 110 may then send a resource grant comprising the assigned uplink resource to terminal 120 (step 7). Terminal 120 may send data on the assigned uplink resource to base station 110 (step 8).

FIGS. 3 and 4 show two designs of bootstrapping for downlink broadcast/uplink access and uplink data. Bootstrapping for downlink control, uplink control, and downlink data may also be performed by exchanging messages between terminal 120, base station 110, and possibly neighbor base stations and/or interfering terminals.

In the design shown in FIG. 4, the reduce interference requests from base stations 110 and 112 may be triggered by resource requests from terminals 120 and 122, respectively. Each reduce interference request may convey specific uplink resource for which reduced interference is requested, the priority of the request, the duration of the request, etc. Each terminal may reduce its transmit power as indicated by the reduce interference requests received from neighbor base stations. The interference mitigation in FIG. 4 may thus be short-term and may be achieved by sending reduce interference requests to potentially interfering terminals in neighbor cells.

In another design of interference mitigation, a load indication from a base station may indicate whether terminals in neighbor cells (or neighbor terminals) should reduce their transmit power. For example, if the load indication indicates light or no loading, then the neighbor terminals may operate without regards to the base station. Conversely, if the load indication indicates heavy loading, then the neighbor terminals may reduce their transmit power. The amount of reduction in transmit power may be dependent on various factors such as the base station loading, the path loss to the base station, etc.

A terminal may receive load indications from one or more neighbor base stations and may adjust its transmit power accordingly. The terminal may use high transmit power when the load indications from the neighbor base stations indicate light or no loading. The terminal may use lower transmit power when the load indication from any neighbor base station indicates heavy loading.

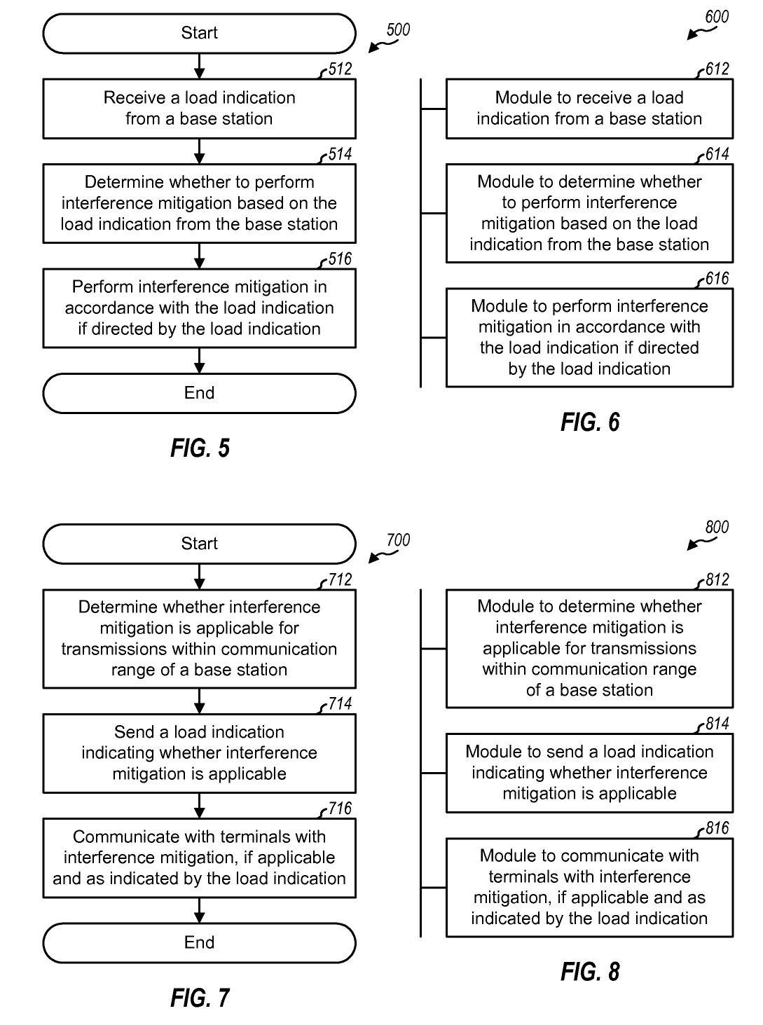

FIG. 5 shows a design of a process 500 performed by a terminal for interference mitigation. The terminal may receive a load indication from a base station (block 512). The terminal may determine whether to perform interference mitigation based on the load indication from the base station (block 514). The terminal may perform interference mitigation in accordance with the load indication if directed by the load indication (block 516).

In one design of blocks 514 and 516, the terminal may determine whether to obtain reserved resources having reduced interference based on the load indication. The reserved resources may comprise downlink resources for sending broadcast information, uplink resources for sending access request, downlink resources for sending control information, uplink resources for sending control information, downlink resources for sending data, and/or uplink resources for sending data. The terminal may send a message to a neighbor base station to obtain the reserved resources, e.g., as shown in FIG. 3. Reduced interference on the reserved resources may be achieved via the neighbor base station, which may reduce its transmit power and/or ask terminals to reduce their transmit power on the reserved resources.

In another design of blocks 514 and 516, the terminal may receive the load indication from a neighbor base station and may determine whether to reduce its transmit power, to request for resources prior to transmission, or to perform some other action based on the load indication from the neighbor base station. The terminal may determine whether to reduce its transmit power to a predetermined level or lower based on the load indication from the neighbor base station. The terminal may (i) reduce its transmit power if the load indication indicates heavy loading at the neighbor base station or (ii) not reduce its transmit power if the load indication indicates light or no loading.

The terminal may determine an interference mitigation scheme to use from among multiple interference mitigation schemes based on the load indication. The terminal may also determine the duration of interference mitigation or the resources selected for interference mitigation based on the load indication. The terminal may also determine whether to access the base station based on the load indication. The terminal may also obtain at least one performance metric for the base station from the load indication and may send the at least one performance metric to a neighbor base station. The terminal may also obtain other information and/or perform other actions based on the load indication.

FIG. 6 shows a design of an apparatus 600 for interference mitigation. Apparatus 600 includes a module 612 to receive a load indication from a base station, a module 614 to determine whether to perform interference mitigation based on the load indication from the base station, and a module 616 to perform interference mitigation in accordance with the load indication if directed by the load indication.

FIG. 7 shows a design of a process 700 performed by a base station for interference mitigation. The base station may determine whether interference mitigation is applicable for transmissions within communication range of the base station (block 712). The base station may make this determination based on loading at the base station, the number of terminals communicating with the base station, at least one performance metric for the base station, and/or other factors, as described above. The base station may send a load indication indicating whether interference mitigation is applicable for the base station (block 714). The base station may communicate with terminals with interference mitigation, if applicable and as indicated by the load indication (block 716).

In one design, the base station may determine whether to seek reduction in interference from terminals communicating with neighbor base stations. If a decision is made to seek reduction in interference, then the base station may send the load indication to request the terminals communicating with the neighbor base stations to reduce their transmit power, to request for resources prior to transmission, and/or to perform some other action.

In another design, the base station may send the load indication to inform terminals communicating with the base station to request for reserved resources having reduced interference. The reserved resources may comprise downlink resources for sending broadcast information, uplink resources for sending access request, downlink resources for sending control information, uplink resources for sending control information, downlink resources for sending data, and/or uplink resources for sending data. The base station may exchange at least one message with a neighbor base station to obtain reserved resources having reduced interference and may use the reserved resources for communication with a terminal.

The base station may select an interference mitigation scheme from among multiple interference mitigation schemes. The base station may then generate the load indication to convey the selected interference mitigation scheme to be used by terminals within communication range of the base station. The base station may also generate the load indication to convey the duration over which interference mitigation is applicable and/or resources for which interference mitigation is applicable. The base station may also determine at least one performance metric for the base station and may send the at least one performance metric in the load indication. The base station may also send other information and/or direct terminals to perform other actions via the load indication.

FIG. 8 shows a design of an apparatus 800 for interference mitigation. Apparatus 800 includes a module 812 to determine whether interference mitigation is applicable for transmissions within communication range of a base station, a module 814 to send a load indication indicating whether interference mitigation is applicable, and a module 816 to communicate with terminals with interference mitigation, if applicable and as indicated by the load indication.

The modules in FIGS. 6 and 8 may comprise processors, electronics devices, hardware devices, electronics components, logical circuits, memories, etc., or any combination thereof.

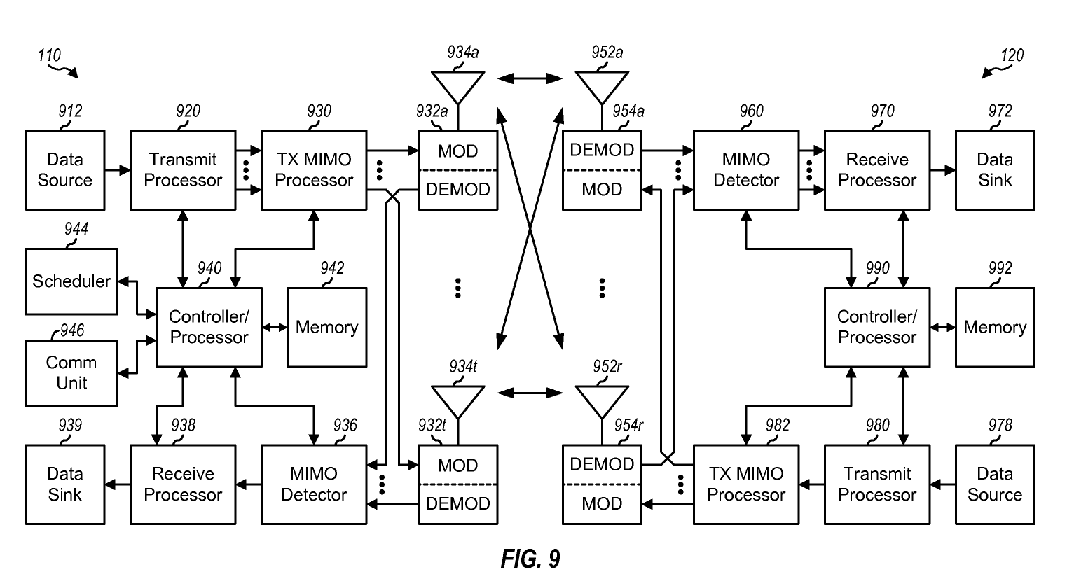

FIG. 9 shows a block diagram of a design of base station 110 and terminal 120. In this design, base station 110 is equipped with T antennas 934a through 934t, and terminal 120 is equipped with R antennas 952a through 952r, where in general T≧1 and R≧1.

At base station 110, a transmit processor 920 may receive data for one or more terminals from a data source 912, process (e.g., encode and modulate) the data for each terminal based on one or more modulation and coding schemes, and provide data symbols for all terminals. Transmit processor 920 may also receive broadcast and control information (e.g., load indication, resource grant, reduce interference request, transmit capability request, etc.) from a controller/processor 940, process the information, and provide overhead symbols. A transmit (TX) multiple-input multiple-output (MIMO) processor 930 may multiplex the data symbols, the overhead symbols, and pilot symbols, process (e.g., precode) the multiplexed symbols, and provide T output symbol streams to T modulators (MOD) 932a through 932t. Each modulator 932 may process a respective output symbol stream (e.g., for OFDM) to obtain an output sample stream. Each modulator 932 may further process (e.g., convert to analog, amplify, filter, and upconvert) the output sample stream to obtain a downlink signal. T downlink signals from modulators 932a through 932t may be transmitted via T antennas 934a through 934t, respectively.

At terminal 120, R antennas 952a through 952r may receive the downlink signals from base station 110 and provide received signals to demodulators (DEMOD) 954a through 954r, respectively. Each demodulator 954 may condition (e.g., filter, amplify, downconvert, and digitize) a respective received signal to obtain received samples and may further process the received samples (e.g., for OFDM) to obtain received symbols. A MIMO detector 960 may perform MIMO detection on the received symbols from all R demodulators 954a through 954r and provide detected symbols. A receive processor 970 may process the detected symbols, provide decoded data for terminal 120 to a data sink 972, and provide decoded broadcast and control information to a controller/processor 990.

On the uplink, at terminal 120, data from a data source 978 and control information (e.g., access request, association request, resource request, etc.) from controller/processor 990 may be processed by a transmit processor 980, precoded by a TX MIMO processor 982 (if applicable), conditioned by modulators 954a through 954r, and transmitted via antennas 952a through 952r. At base station 110, the uplink signals from terminal 120 may be received by antennas 934, conditioned by demodulators 932, detected by a MIMO detector 936, and processed by a receive processor 938 to obtain the data and control information transmitted by terminal 120.

Controllers/processors 940 and 990 may direct the operation at base station 110 and terminal 120, respectively. Controller/processor 940 at base station 110 may implement or direct process 700 in FIG. 7 and/or other processes for the techniques described herein. Controller/processor 990 at terminal 120 may implement or direct process 500 in FIG. 5 and/or other processes for the techniques described herein. Memories 942 and 992 may store data and program codes for base station 110 and terminal 120, respectively. A scheduler 944 may schedule terminals for transmissions on the downlink and/or uplink and may assign resources to the scheduled terminals. A communication (Comm) unit 946 may support communication with other base stations and system controller 130 via the backhaul.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
receiving a load indication from a base station; and
determining whether to perform interference mitigation based on the load indication from the base station.

2. The method of claim 1, wherein the determining whether to perform interference mitigation comprises determining whether to obtain reserved resources having reduced interference based on the load indication.

3. The method of claim 2, further comprising:
sending a message to a neighbor base station to obtain the reserved resources, wherein reduced interference on the reserved resources is achieved via the neighbor base station.

4. The method of claim 2, wherein the reserved resources comprise at least one of downlink resources for sending broadcast information, uplink resources for sending access request, downlink resources for sending control information, uplink resources for sending control information, downlink resources for sending data, and uplink resources for sending data.

5. The method of claim 1, wherein the receiving the load indication comprises receiving the load indication from a neighbor base station, and wherein the determining whether to perform interference mitigation comprises determining whether to reduce transmit power or to request for resources prior to transmission based on the load indication from the neighbor base station.

6. The method of claim 5, wherein the determining whether to reduce transmit power comprises determining whether to reduce transmit power to a predetermined level or lower based on the load indication from the neighbor base station.

7. The method of claim 5, further comprising:
reducing transmit power if the load indication indicates heavy loading at the neighbor base station; and
not reducing transmit power if the load indication indicates light or no loading at the neighbor base station.

8. The method of claim 1, further comprising:
determining an interference mitigation scheme to use from among multiple interference mitigation schemes based on the load indication.

9. The method of claim 1, further comprising:
determining duration of interference mitigation or resources selected for interference mitigation based on the load indication.

10. The method of claim 1, further comprising:
determining whether to access the base station based on the load indication.

11. The method of claim 1, further comprising:
obtaining at least one performance metric for the base station from the load indication; and
sending the at least one performance metric to a neighbor base station.

12. An apparatus for wireless communication, comprising:
at least one processor configured to receive a load indication from a base station, and to determine whether to perform interference mitigation based on the load indication from the base station.

13. The apparatus of claim 12, wherein the at least one processor is configured to determine whether to obtain reserved resources having reduced interference based on the load indication.

14. The apparatus of claim 12, wherein the at least one processor is configured to receive the load indication from a neighbor base station, and to determine whether to reduce transmit power or to request for resources prior to transmission based on the load indication from the neighbor base station.

15. An apparatus for wireless communication, comprising:
means for receiving a load indication from a base station; and
means for determining whether to perform interference mitigation based on the load indication from the base station.

16. The apparatus of claim 15, wherein the means for determining whether to perform interference mitigation comprises means for determining whether to obtain reserved resources having reduced interference based on the load indication.

17. The apparatus of claim 15, wherein the means for receiving the load indication comprises means for receiving the load indication from a neighbor base station, and wherein the means for determining whether to perform interference mitigation comprises means for determining whether to reduce transmit power or to request for resources prior to transmission based on the load indication from the neighbor base station.

18. A computer program product, comprising:
a computer-readable medium comprising:
code for causing at least one computer to receive a load indication from a base station, and
code for causing the at least one computer to determine whether to perform interference mitigation based on the load indication from the base station.

19. A method for wireless communication, comprising:
determining whether interference mitigation is applicable for transmissions within communication range of a base station; and
sending a load indication indicating whether interference mitigation is applicable.

20. The method of claim 19, wherein the determining comprises determining whether interference mitigation is applicable based on loading at the base station, number of terminals communicating with the base station, or at least one performance metric for the base station.

21. The method of claim 19, wherein the determining comprises determining whether to seek reduction in interference from terminals communicating with neighbor base stations, and wherein the sending the load indication comprises sending the load indication to request the terminals communicating with the neighbor base stations to reduce transmit power or to request for resources prior to transmission if a decision is made to seek reduction in interference.

22. The method of claim 19, wherein the sending the load indication comprises sending the load indication to inform terminals communicating with the base station to request for reserved resources having reduced interference.

23. The method of claim 19, further comprising:
exchanging at least one message with a neighbor base station to obtain reserved resources having reduced interference; and
using the reserved resources for communication with a terminal.

24. The method of claim 22, wherein the reserved resources comprise at least one of downlink resources for sending broadcast information, uplink resources for sending access request, downlink resources for sending control information, uplink resources for sending control information, downlink resources for sending data, and uplink resources for sending data.

25. The method of claim 19, further comprising:
selecting an interference mitigation scheme from among multiple interference mitigation schemes; and
generating the load indication to convey the selected interference mitigation scheme to be used by terminals within communication range of the base station.

26. The method of claim 19, further comprising:
generating the load indication to convey duration over which interference mitigation is applicable or resources for which interference mitigation is applicable.

27. The method of claim 19, wherein the sending the load indication comprises sending the load indication periodically in each predetermined time duration.

28. An apparatus for wireless communication, comprising:
at least one processor configured to determine whether interference mitigation is applicable for transmissions within communication range of a base station, and to send a load indication indicating whether interference mitigation is applicable.

29. The apparatus of claim 28, wherein the at least one processor is configured to determine whether interference mitigation is applicable based on loading at the base station, number of terminals communicating with the base station, or at least one performance metric for the base station.

30. The apparatus of claim 28, wherein the at least one processor is configured to determine whether to seek reduction in interference from terminals communicating with neighbor base stations and, if a decision is made to seek reduction in interference, to send the load indication to request the terminals communicating with the neighbor base stations to reduce transmit power or to request for resources prior to transmission.

31. The apparatus of claim 28, wherein the at least one processor is configured to send the load indication to inform terminals communicating with the base station to request for reserved resources having reduced interference.

32. The apparatus of claim 28, wherein the at least one processor is configured to exchange at least one message with a neighbor base station to obtain reserved resources having reduced interference, and to use the reserved resources for communication with a terminal.

33. A method for wireless communication, comprising:
determining at least one performance metric for a base station; and
sending a load indication comprising the at least one performance metric to terminals.

34. The method of claim 33, wherein the at least one performance metric conveys at least one of a number of terminals being served by the base station, typical performance of the terminals being served, and resources available to newly arriving terminals.

35. The method of claim 33, wherein the at least one performance metric is used by the terminals to determine whether to access the base station or whether to perform interference mitigation.
